(19) United States
(12) Patent Application Publication
(10) Pub. No.: US 2008/0308395 A1
(43) Pub. Date: Dec. 18, 2008

(54) SWITCH

(76) Inventor: Motoyoshi MURAKAMI, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/140,469

(22) Filed: Jun. 17, 2008

(30) Foreign Application Priority Data
Jun. 18, 2007 (JP) 2007-159793

(51) Int. Cl. H01H 1/02

(52) U.S. Cl. 200/268

(57) ABSTRACT

A switch has a case, a fixed contact, and a movable contact. The fixed contact is planted on an inner wall of the case and has a first metal layer on its surface. The movable contact is housed in the case in a movable manner, is in elastic contact with the fixed contact, and has a second metal layer on its surface. The first metal layer and the second metal layer have luster.

### BACKGROUND OF THE INVENTION

1. Field of the Invention

The present invention relates to a switch to be used primarily for controlling turning on and off stop lamps of a vehicle when an automotive brake pedal is operated.

2. Background Art

In recent years, depressing type switches are used in many vehicles for controlling stop lamps in association with brake pedal operation. In such control, stop lamps are turned on when the brake pedal is depressed and turned off when the brake pedal is released. A description of such a conventional push switch will be given referring to FIG. 7.

FIG. 7 is a sectional view of a conventional push switch. Switch 10 has case 1, a pair of fixed contacts 2, operating member 3 and movable contact 4. Case 1 made of an insulating resin is boxy with its upper face open. Fixed contact 2 is formed in the shape of letter “C” or “L” using a copper alloy and the like. Fixed contacts 2 are oppositely planted on the right and left inner walls of case 1. Terminals 2A of fixed contacts 2 protrude from bottom face of case 1.

Operating member 3 made of an insulating resin is housed inside case 1 in a manner vertically movable. Movable contact 4 is formed in the form of letter “C” using a copper alloy. Lower end of operating member 3 holds movable contact 4 at its intermediate part. Movable contact 4 has arm sections 4A each extending to right or left, and each contact section 4B formed at each tip is in elastic contact with fixed contact 2 with arm section 4A slightly bent. With this contact, fixed contacts 2 are electrically connected through movable contact 4.

Coiled spring 5 is mounted between the lower face of operating member 3 and the inner bottom face of case 1 in a slightly compressed state and urges operating member 3 upwardly. Cover 6 covers the opening of case 1 in such a manner that the tip of operating member 3 protrudes upwardly from hollow cylinder 6A provided in the center of cover 6. Switch 10 is installed so as to interlock with the break pedal and is used for on/off control of the stop lamps.

When operating member 3 is depressed while compressing spring 5, movable contact 4 moves downwardly and each contact sections 4B is separated from fixed contact 2. With this action, fixed contacts 2 become electrically disconnected.

On the other hand, on removing the depressing force onto operating member 3, operating member 3 moves upwardly due to elastic restoring force of spring 5 and each contact section 4B of movable contact 4 comes in elastic contact with fixed contact 2. As a result, fixed contacts 2 become electrically connected through movable contact 4.

In switch 10 with such a structure, the elastic contacting force, so-called contact pressure, of contact sections 4B of movable contact 4 toward fixed contact 2 is normally set at about 0.1 to 1 N. Meanwhile, in case light-emitting diodes are used for the stop lamps, a current in the range from 30 to 100 mA is applied across fixed contact 2 and movable contact 4 at a DC voltage in the range from 12 to 14 V.

Accordingly, practically no arc will be generated when contact section 4B and fixed contact 2 come in contact or are separated. Consequently, practically no abrasion of movable contact 4 and fixed contacts 2 will occur due to such an arc. However, as contact section 4B is in elastic contact with fixed contact 2 with a relatively large force of about 0.1 to 1 N, contact sections 4B and fixed contacts 2 are mechanically worn by repeated depressing operation. When depressing operation is further repeated to produce abrasion powder from contact section 4B and fixed contact 2, minute arcs are generated at each contact/separate action and the temperatures of contact sections 4B and fixed contacts 2 that are in elastic contact rise due to a current flow. As a result, abrasion is promoted. More specifically, in the event on/off operation is repeated hundred thousand times or more, for example, there occurs a case in which electrical connection becomes unstable due to abrasion of the surfaces of movable contact 4 and fixed contacts 2.

As a countermeasure to this problem, there is a method to coat a lubricant such as grease and oil to movable contact 4 and fixed contacts 2. However, when abrasion powder is mixed into the lubricant after repeating depression operation, arcs are generated by contact/separate action and abrasion is accelerated. Accordingly, this method has limitation in enhancing abrasion resistance and maintaining stabilized electrical connection over a long period.

### SUMMARY OF THE INVENTION

The present invention provides a switch that assures secure electrical contact/separate action with a simple structure. The switch in accordance with the present invention has a case, a fixed contact, and a movable contact. The fixed contact is planted on an inner wall of the case and has a first metal layer on a surface. The movable contact is housed inside the case in a movable manner and in elastic contact with the fixed contact, and has a second metal layer on a surface. The first metal layer and the second metal layer have luster. Owing to the first metal layer and the second metal layer formed in this way on the surfaces of the fixed contact and the movable contact, respectively, the fixed contact and the movable contact keep elastic, smooth and sliding contact. Accordingly, even when switching operation is repeated over a long period of time, abrasion of the first metal layer and the second metal layer is small. As a result, the fixed contact and the movable contact can keep secure and stable electrical contact/separate action over the long period of time.

### BRIEF DESCRIPTION OF DRAWINGS

FIG. 1 is a sectional view of a switch in accordance with an embodiment of the present invention.

FIG. 2 is an exploded perspective view of the switch shown in FIG. 1.

FIG. 3 is an enlarged sectional view of a movable contact and a fixed contact of the switch shown in FIG. 1.

FIG. 4 is a sectional view of the switch of FIG. 1 when operated.

FIG. 5A to FIG. 5C are partial side views of the switch of FIG. 1 during operation.

FIG. 6 is a side view of a brake pedal that uses the switch shown in FIG. 1.

FIG. 7 is a sectional view of a conventional switch.

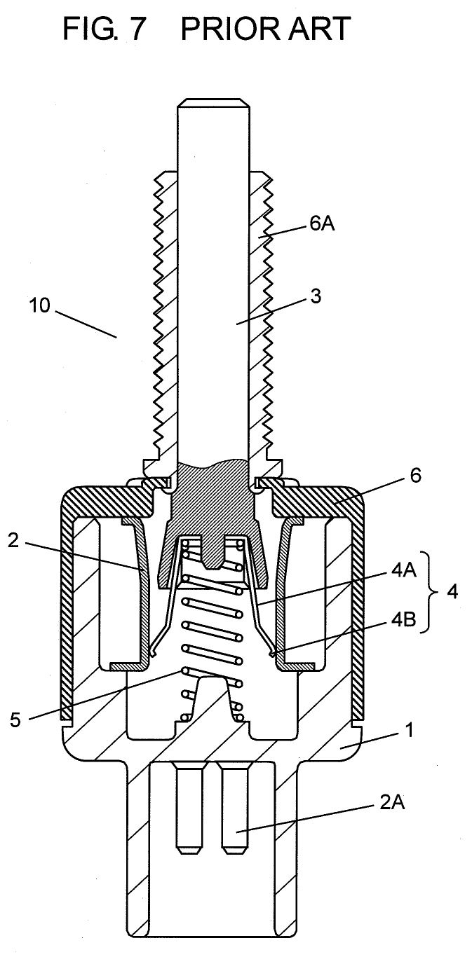

### DETAILED DESCRIPTION OF THE INVENTION

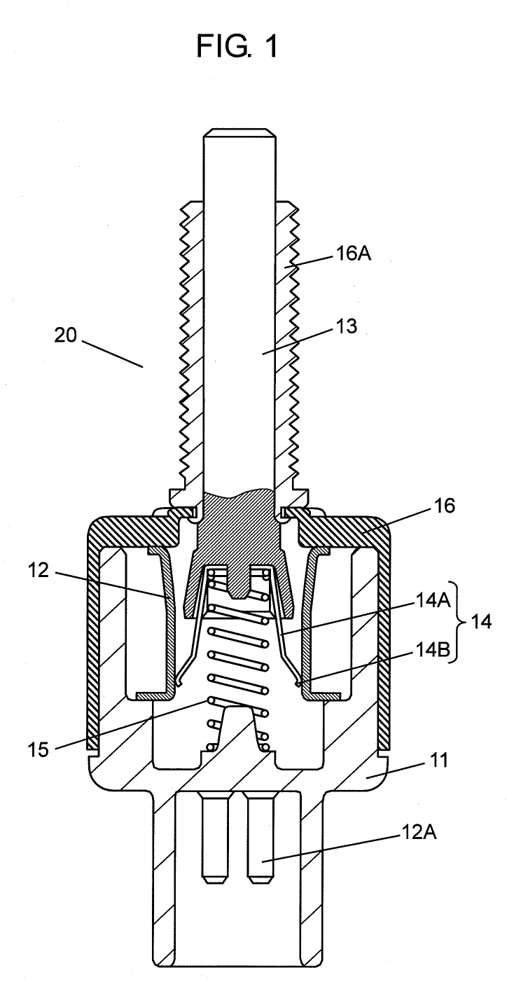

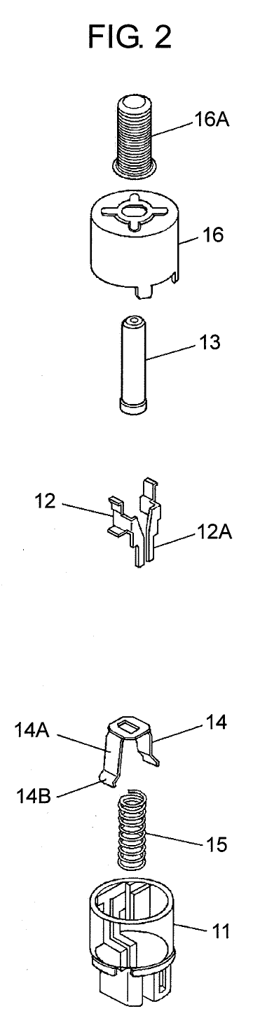

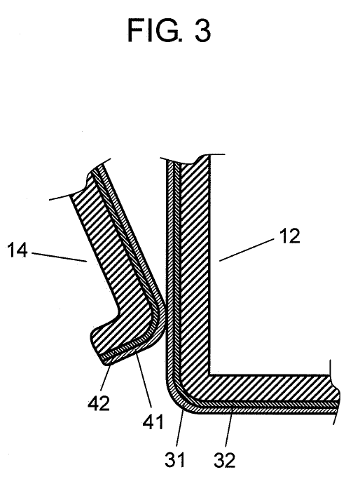

FIG. 1 is a sectional view of a switch in accordance with an exemplary embodiment of the present invention. FIG. 2 is an exploded perspective view thereof. FIG. 3 is an enlarged sectional view of a movable contact and a fixed contact of the switch. Switch 20 has case 11, fixed contacts 12 and movable contact 14.

Case 11 having an upper opening is boxy and is made of an insulating resin such as polybutylene terephthalate or acrylonitrile butadiene styrene resin. Fixed contact 12 is roughly in the shape of letter “C” or letter “L” and is formed of a copper alloy such as phosphor bronze and brass. Fixed contacts 12 are planted on the right and left inner walls of case 11 and terminal sections 12A of fixed contacts 12 protrude from the outer bottom face of case 11. Fixed contact 12 has first metal layer (hereinafter referred to as “metal layer”) 31 on a surface.

Movable contact 14 roughly in the shape of letter “C” is formed of a copper alloy and the like such as phosphor bronze and beryllium copper. Operating member 13 made of an insulating resin is housed inside case 11 in a manner vertically movable. Namely, operating member 13 is reciprocable inside case 11. The lower end of operating member 13 holds the intermediate part of movable contact 14. Each contact section 14B formed at the tip is in elastic contact with each fixed contact 12 with arm section 14A extending to right or left being slightly bent. That is, right and left fixed contacts 12 are electrically connected through movable contact 14. In this way, movable contact 14 is housed inside case 11 in a movable manner and is in elastic contact with fixed contacts 12. Movable contact 14 has second metal layer (hereafter referred to as “metal layer”) 41 on a surface.

Furthermore, switch 20 has spring 15 as an elastic body, and cover 16. Spring 15 is formed of a steel wire or copper alloy wire wound into a coil. Cover 16 made of a metal or an insulating resin covers the opening on the top face of case 11. Spring 15 is mounted between the lower face of operating member 13 and the inner bottom face of case 11 in a manner slightly compressed and upwardly urges operating member 13. That is, spring 15 is provided between operating member 13 and case 11 in the movable direction of operating member 13. The tip of operating member 13 protrudes upwardly from hollow cylinder section 16A provided in the center of cover 16.

Metal layers 31 and 41 have luster. To be more precise, metal layers 31 and 41 are formed of metal particles having a uniform particle size of 0.5 μm or smaller, preferably 0.2 μm or smaller. Silver particles are preferable as such metal particles. However, the metal is not limited to silver so far as it has abrasion resistance. In this way, metal layers 31 and 41 with hardness in the range from 100 HV to 160 HV, inclusive, are formed, for example. Accordingly, preferable average surface roughness of metal layers 31, 41 is larger than 0 μm and at most 0.5 μm, more preferably 0.2 μm or smaller. By forming metal layers 31, 41 to this average surface roughness, they can be made to have luster.

The above hardness is defined in JIS Z2244 as Vickers hardness (HV). Vickers hardness (HV) is calculated by formula (I) based on test load (F) applied to make indentations onto a test surface with a Vickers indenter and average value (D) of diagonal length of the indentations.

HV=0.1891 F/D² (1)

Also, average surface roughness is defined in JIS B0601 and JIS B0031.

The thickness of metal layers 31, 41 is preferably 0.05 μm to 100 μm, inclusive, more preferably 1 μm to 50 μm, inclusive, yet more preferably 2 μm to 20 μm, inclusive. The thickness is yet further preferably 3 μm to 10 μm, inclusive. Metal layers 31, 41 can be formed by plating, for example. There is no limitation on the method of formation. The metal layers may be formed by metal deposition, for example. When there is no luster immediately after forming metal layers, the surface may be polished with an abrasive, for example.

Also, it is preferable to provide first under layer 32 and second under layer 42 (hereinafter referred to as “under layers 32, 42”) under metal layers 31, 41, respectively. It is preferable that under layers 32, 42 are also formed with metal particles with a uniform grain size of 0.5 μm or smaller. It is more preferable that they are formed of metal particles with a grain size of 0.2 μm or smaller. As such metal particles, at least one of particles of nickel with hardness range of 300-600 HV, palladium with hardness of about 220 HV, ruthenium and rhodium with hardness of about 800 HV, platinum with hardness of about 280 VH, gold, cobalt, iron, copper and iridium with hardness range of 100-300 HV may be used. In this way, under layers 32, 42 with a hardness in the range of 100 HV to 1,000 HV, inclusive, surface roughness of 0.5 μm or smaller, preferably 0.2 μm or smaller, may be obtained. Thus, it is preferable that the hardness of under layers 32, 42 is equal to or larger than that of metal layers 31, 41.

Also, the preferable range of thickness of under layers 32, 42 is the same as that of metal layers 31, 41.

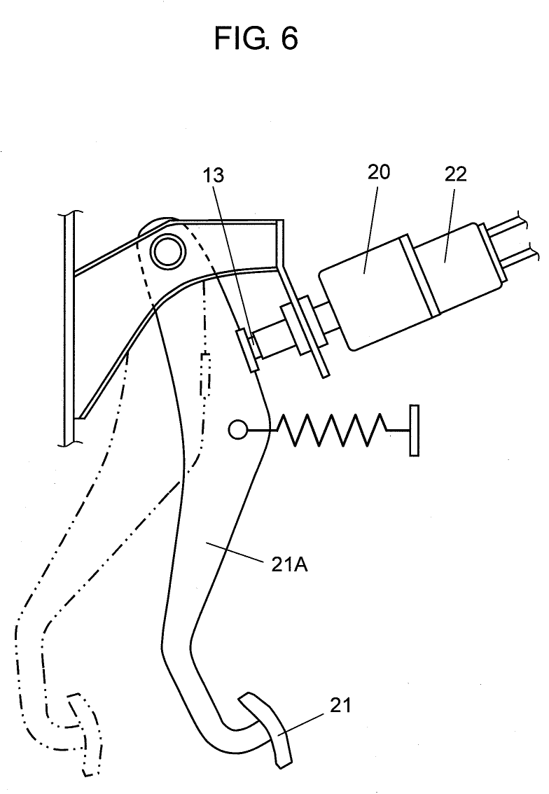

Switch 20 configured in this way is mounted generally in front of a brake pedal of an automobile with the tip of operating member 13 being depressed by arm 21A as shown by the side view in FIG. 6. Also, terminal sections 12A that protrude from the outer bottom face of case 11 is connected to stop lamps and electronic circuits (not shown) of the automobile with connector 22 and lead wires.

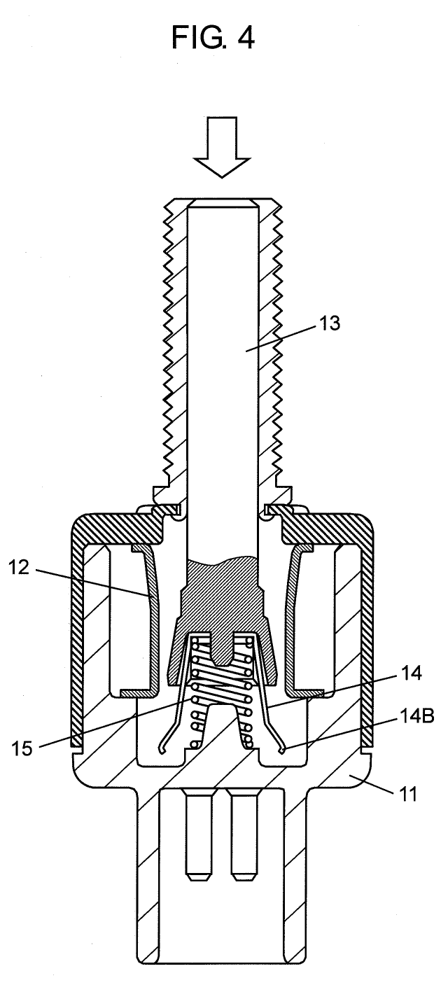

Under a state in which the brake pedal is not depressed, operating member 13 is pushed downwardly while compressing spring 15 as shown in FIG. 4. Accordingly, each contact section 14B of movable contact 14 is separated from side face of fixed contact 12 thus making right and left fixed contacts 12 electrically disconnected. As a result, the stop lamps are turned off.

When brake pedal 21 is depressed, arm 21A is separated from the tip of operating member 13, depressing force is released, and operating member 13 moves upwardly by elastic restoring force of spring 15 as shown in FIG. 1. As a result, each contact section 14B comes in elastic contact with side face of fixed contact 12 thus making left and right fixed contacts 12 electrically connected through movable contact 14. The stop lamps are thus turned on.

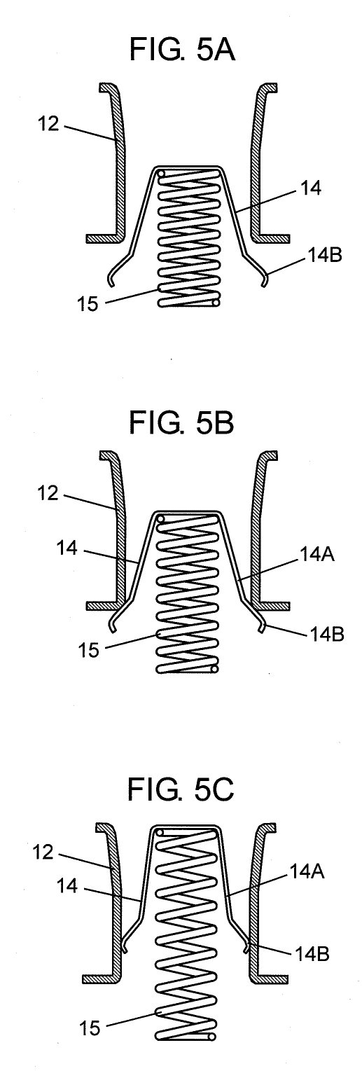

Referring to FIG. 5A to FIG. 5C, description will now be given on the change of state when operating member 13 shifts upwardly due to elastic restoring force of spring 15. FIG. 5A to FIG. 5C are partial side views of the switch shown in FIG. 1 while being operated.

As shown in FIG. 5A, operating member 13 moves upwardly by elastic restoring force of spring 15 from a state in which each contact section 14B of movable contact 14 is separated from a side face of fixed contact 12. And, as shown in FIG. 5B, lower end of each arm section 14A of movable contact 14 comes in elastic contact with the lower end of fixed contact 12.

Subsequently, as shown in FIG. 5C, each contact section 14B rather than arm section 14A comes in contact with a side face of fixed contact 12 in association with upward shift of operating member 13. And contact section 14B elastically slides on side face of fixed contact 12 thus restoring to the state of FIG. 1.

And, even when operating member 13 is pushed down causing movable contact 14 to be separated from fixed contact 12, contact section 14B is first separated from lower end of fixed contact 12 in the same manner. Subsequently, lower end of arm section 14A which is in elastic contact with lower end of fixed contact 12 will also be separated thus electrically disconnecting right and left fixed contacts 12.

That is, in the state in which operating member 13 is depressed downwardly, movable contact 14 is separated from fixed contacts 12 and a gap is formed between them. Immediately after movable contact 14 comes in contact with fixed contacts 12, the lower end of each arm section 14A elastically contacts with lower end of fixed contact 12. In the state in which operating member 13 restores upward, each contact section 14B comes in elastic contact with a side face of fixed contact 12. In this way, switch 20 is configured such that movable contact 14 and fixed contacts 12 come in contact at different locations with the shift of operating member 13.

That is, when electrical contact between movable contact 14 and fixed contacts 12 is released, a gap is formed between them. This gap provides secure insulation between movable contact 14 and fixed contacts 12. Also, when movable contact 14 and fixed contacts 12 come in contact with each other, the point of contact is changed, and movable contact 14 and fixed contacts 12 can keep secure and stable electrical contact even in the event some peripheral dust or moisture enters the switch.

When light-emitting diodes are used as the stop lamps, the voltage and current applied across fixed contacts 12 and movable contact 14 by operating switch 20 are DC 12 to 14 V and 30 to 100 mA. Accordingly, hardly any arc will be generated when contact section 14B and fixed contacts 12 come into contact or are separated. Therefore, hardly any abrasion of movable contact 14 and fixed contacts 12 due to arcs is caused. However, the elastic contact force of contact section 14B toward each fixed contact 12, or the so-called contact pressure, is normally set to a relatively large value of 0.1 to 1 N.

Accordingly, when the above depressing operation is repeated over a long period of time, mechanical wear tends to occur at the elastic contact point between fixed contacts 12 and movable contact 14. As an example, under layer layers 32, 42 are formed using copper having about 3 HV hardness, and lusterless metal layers 31, 41 are formed on under layers 32, 42 by using silver particles with a grain size of several μm. Metal layers 31, 41 in this case have about 50˜100 HV hardness, and average surface roughness of 1 μm or larger. And each contact section 14B is made to elastically contact with fixed contact 12 with a contact pressure of about 0.1 to 1 N. By repeating depression operation in this configuration, contact sections 14B and fixed contacts 12 are mechanically worn. If abrasion powder is produced by contact sections 14B and fixed contacts 12 due to further repetition of depression operation, minute arcs is generated by on/off action causing temperature rise due to a current passing through contact section 14B and fixed contact 12 which are in elastic contact. As a result, abrasion is accelerated. That is, when operation is repeated hundred thousand times or more, for example, there may occur a case in which electrical connection becomes unstable due to abrasion of the surfaces of movable contact 14 and fixed contacts 12.

On the other hand, in this exemplary embodiment, metal layers 31, 41 having a large hardness value, small surface roughness, and luster are formed on fixed contacts 12 and movable contact 14. For this reason, even after repetition of operation of three hundred thousand times, abrasion of metal layers 31, 41 will be reduced, and under layers 32, 42 and base metals of fixed contacts 12 and movable contact 14 are not exposed. In this exemplary embodiment, abrasion resistance of metal layers 31, 41 is enhanced and stable electrical on/off action can be sustained over a long period of time as described above.

In addition, movable contact 14 elastically contacts and slides on fixed contacts 12 in a smooth way owing to metal layers 31, 41. Accordingly, even when depression operation is repeated over a long period of time, abrasion powder is not easily produced. Consequently, scarcely any arc is generated due to abrasion powder.

Furthermore, it is preferable to provide under layers 32, 42 beneath metal layers 31, 41, respectively. Under layers 32, 42 are formed of uniform and small grain size particles of at least one of nickel, palladium, ruthenium, rhodium, platinum, gold, cobalt, iron, copper, and iridium. Also, hardness of under layers 32, 42 is in the range of 100 HV to 1,000 HV, inclusive, with average surface roughness of 0.5 μm or smaller. For this reason, abrasion resistance due to repeated operation is further enhanced thus permitting stable electrical connection over a longer period of time.

Meanwhile, as mentioned above, metal layers 31, 41 are formed of uniform silver particles with a grain size of 0.5 μm or smaller, preferably 0.2 μm or smaller. In addition, brightener or hardening agents such as antimony, phosphor, boron, carbon, nitrogen, nickel, silicon, and selenium may also be added. Metal layers 31, 41 may also be formed relatively easily by increasing the current density of electric plating or intermittingly shutting off electric current.

According to this exemplary embodiment, elastic sliding contact of fixed contacts 12 and movable contact 14 can be performed owing to metal layers 31, 41. Accordingly, a switch can be made that has small abrasion of metal layers 31, 41 and can perform secure and stable electrical on/off action even when switching operation is repeated over a long period of time.

Also, by forming under layers 32, 42 underneath metal layers 31, 41, abrasion resistance can be further enhanced thereby assuring stable electrical connection over a long period of time.

In this exemplary embodiment, though description is made taking a push switch as an example, the present invention is not limited to the type of switch. Metal layers 31, 41 may be applied to a slide switch, for example, in which a movable contact comes into elastic contact with a fixed contact.

As described above, the switch in accordance with the present invention allows secure electrical on/off action with a simple structure. This switch is useful primarily for turning on or off automotive stop lamps.

What is claimed is:

1. A switch comprising:
a case,
a fixed contact planted on an inner wall of the case and having a first metal layer on a surface, and
a movable contact movably housed inside the case, in elastic contact with the fixed contact, and having a second metal layer on a surface wherein
the first metal layer and the second metal layer have luster.

2. The switch according to claim 1,
wherein the average surface roughness of the first metal layer and the second metal layer is larger than 0 μm and at most 0.5 μm.

3. The switch according to claim 1 further comprising an operating member housed and reciprocable inside the case, the operating member supporting the movable contact.

4. The switch according to claim 3 further comprising an elastic member provided between the operating member and the case along a reciprocable direction of the operating member.

5. The switch according to claim 1,
wherein the hardness of the first metal layer and the second metal layer is at least 100 HV and at most 160 HV.

6. The switch according to claim 1,
wherein the first metal layer and the second metal layer are formed of silver.

7. The switch according to claim 1,
wherein the first metal layer and the second metal layer are silver plated layers.

8. The switch according to claim 1,
wherein the fixed contact has a first under layer beneath the first metal layer, the first under layer having a hardness equal to the hardness of the first metal layer or more; and
the movable contact has a second under layer beneath the second metal layer, the second under layer having a hardness 1 equal to the hardness of the second metal layer or more.

9. The switch according to claim 8,
wherein the hardness of the first metal layer and the second metal layer is at least 100 HV and at most 160 HV, and the hardness of the first under layer and the second under layer is at least 100 HV and at most 1,000 HV.

10. The switch according to claim 8
wherein the first under layer and the second under layer are formed of particles of at least one of nickel, palladium, ruthenium, rhodium, platinum, gold, cobalt, iron, copper, and iridium.
